(19) United States
(12) Patent Application Publication
(10) Pub. No.: US 2025/0310400 A1
(43) Pub. Date: Oct. 2, 2025

(54) VIRTUALIZATION PLATFORM SOFTWARE UPDATE AND MIGRATION

(71) Applicant: Rakuten Mobile, Inc., Tokyo (JP)

(72) Inventors: Amit SINGH, Tokyo (JP); Tatsuya TOYAMA, Tokyo (JP)

(73) Assignee: Rakuten Mobile, Inc., Tokyo (JP)

(21) Appl. No.: 18/756,042

(22) Filed: Jun. 27, 2024

(30) Foreign Application Priority Data
Mar. 28, 2024 (JP) 2024-053496

(51) Int. Cl. H04L 67/1095; G06F 8/65; H04L 41/40

(52) U.S. Cl. CPC H04L 67/1095; G06F 8/65; H04L 41/40

(57) ABSTRACT

An information processing apparatus performs preparation process, first formation process, migration process, second formation process, and control process. The preparation process includes preparing, as a reserved node, one or more nodes in which one or more applications are not built on a first virtualization platform among a plurality of nodes in which the first virtualization platform is formed. The first formation process includes forming a second virtualization platform in the reserved node. The migration process includes migrating the one or more applications built on the first virtualization platform formed in a first node among the plurality of nodes to any second node among the one or more nodes in which the second virtualization platform is formed. The second formation process includes forming the second virtualization platform in the first node. The control process includes performing control to repeat the migration process and the second formation process.

### CROSS-REFERENCE TO RELATED APPLICATION(S)

This application claims priority to Japanese patent application No. 2024-053496, filed on Mar. 28, 2024; the entire contents of which are incorporated herein by reference.

### TECHNICAL FIELD

The present disclosure relates to virtualization platform software update and migration.

### BACKGROUND ART

In recent years, much software for implementing a virtualization platform (hereinafter, also referred to as virtualization platform software) has been developed. By forming a virtualization platform in a plurality of physical servers (nodes) using virtualization platform software, it is possible to build one virtual resource and execute a plurality of applications on the virtualization platform. In the related art, OpenStack and Kubernetes are known as open source virtualization platform software.

As a method of updating the virtualization platform software, in the related art, a rolling (in-place) update method and a blue-green method are known. The rolling update method is a method of updating the virtualization platform software for each server in the cluster (that is, one by one) while distributing the load of the application among different servers. The blue-green method is a method of updating the virtualization platform software by preparing another cluster of new (that is, updated) environments and migrating applications while performing load balancing. The rolling update method has a feature that an additional resource is not required but it takes a long time to complete the update, and the blue-green method has a feature that a time to complete the update is shortened but an additional resource is required.

WO 2023/275926 A discloses a method for returning to a state before occurrence of a problem when the problem occurs during update of an application on a virtualization platform and executing update with fewer resources than the blue-green method.

### SUMMARY OF THE INVENTION

The technique disclosed in the above document is directed to updates to the same virtualization platform software. On the other hand, as described above, since there is a plurality of types of virtualization platform software such as OpenStack and Kubernetes, a scenario in which currently used software is migrated to different software in consideration of the advantages of each software is also conceivable. In such a scenario, in order to perform the migration of the software in a shorter time, an additional resource is required when the migration is performed in the blue-green method.

In addition, in edge computing in which a server (edge server) or the like is deployed at the periphery (edge) of a network and an application is executed on the edge server, resources of the edge server are generally very limited. Therefore, when the update of the virtualization platform software is executed in the edge server, it is required to execute the update more efficiently without requiring additional resources.

In view of such problems, an object of the present disclosure is to provide a technique for efficiently updating and migrating virtualization platform software without requiring additional resources.

An information processing apparatus according to one aspect of the present disclosure executes a preparation process, a first formation process, a migration process, a second formation process, and a control process. The preparation process includes preparing, as one or more reserved nodes, one or more nodes in which one or more applications are not built on a first virtualization platform among a plurality of nodes in which the first virtualization platform is formed. The first formation process includes forming a second virtualization platform in the one or more reserved nodes. The migration process includes migrating the one or more applications built on the first virtualization platform formed in a first node among the plurality of nodes to any second node among the one or more nodes in which the second virtualization platform is formed. The second formation process includes forming the second virtualization platform in the first node. The control process includes performing control to repeat the migration process and the second formation process until the second virtualization platform is formed in all of the plurality of nodes.

An information processing apparatus according to one aspect of the present disclosure executes a first setting process, a preparation process, a first formation process, a migration process, a second formation process, a second setting process, and a control process. The first setting process includes setting a variable n to 1. The preparation process includes preparing an n-th node in which one or more applications are not built on a first virtualization platform among N nodes from first to N-th (natural numbers of N>1) in which the first virtualization platform is formed. The first formation process includes forming a second virtualization platform in the n-th node. The migration process includes migrating the one or more applications built on the first virtualization platform of an (n+1)th node among the N nodes to the n-th node. The second formation process includes forming the second virtualization platform in the (n+1)th node. The second setting process includes incrementing n by 1. The control process includes performing control to repeat the migration process, the second formation process, and the second setting process until the second virtualization platform is formed in all of the N nodes.

An information processing method according to an aspect of the present disclosure includes: preparing, as one or more reserved nodes, one or more nodes in which one or more applications are not built on a first virtualization platform among a plurality of nodes in which the first virtualization platform is formed; forming a second virtualization platform in the one or more reserved nodes; migrating the one or more applications built on the first virtualization platform formed in a first node among the plurality of nodes to any second node among the one or more nodes in which the second virtualization platform is formed; forming the second virtualization platform in the first node; and performing control to repeat the mitigating and the forming the second virtualization platform in the first node until the second virtualization platform is formed in all of the plurality of nodes.

According to the technology of the present disclosure, it is possible to efficiently perform update and migration of the virtualization platform software without requiring additional resources.

Objects, aspects, and effects of the present invention described above and objects, aspects, and effects of the present invention not described above will be understood by those skilled in the art from the following embodiments with reference to the accompanying drawings and the description of the claims.

### BRIEF DESCRIPTION OF THE DRAWINGS

FIG. 1A illustrates a configuration example of an information processing system according to an embodiment.

FIG. 1B illustrates a configuration example of an information processing system according to an embodiment.

FIG. 1C illustrates a configuration example of an information processing system according to an embodiment.

FIG. 1D illustrates a configuration example of an information processing system according to an embodiment.

FIG. 1E illustrates a configuration example of an information processing system according to an embodiment.

FIG. 1F illustrates a configuration example of an information processing system according to an embodiment.

FIG. 2 illustrates a flowchart of processing executed by the information processing apparatus according to the embodiment.

FIG. 3 illustrates an exemplary network configuration of a communication system with edge computing.

FIG. 4 illustrates a hardware configuration example of the information processing apparatus according to the embodiment.

### EMBODIMENTS OF THE INVENTION

Hereinafter, an embodiment of the present disclosure will be described in detail with reference to the accompanying drawings. Among the components disclosed below, components having the same function are denoted by the same reference symbols, and the description thereof will be omitted. Note that the embodiment disclosed below is one embodiment of the present disclosure, and should be appropriately modified or changed in accordance with the configuration of the apparatus and various conditions, and the present disclosure is not limited to the following embodiment only. In addition, all combinations of features described in the present embodiment are not necessarily essential to solution of the above-described problem.

### Configuration of Communication System

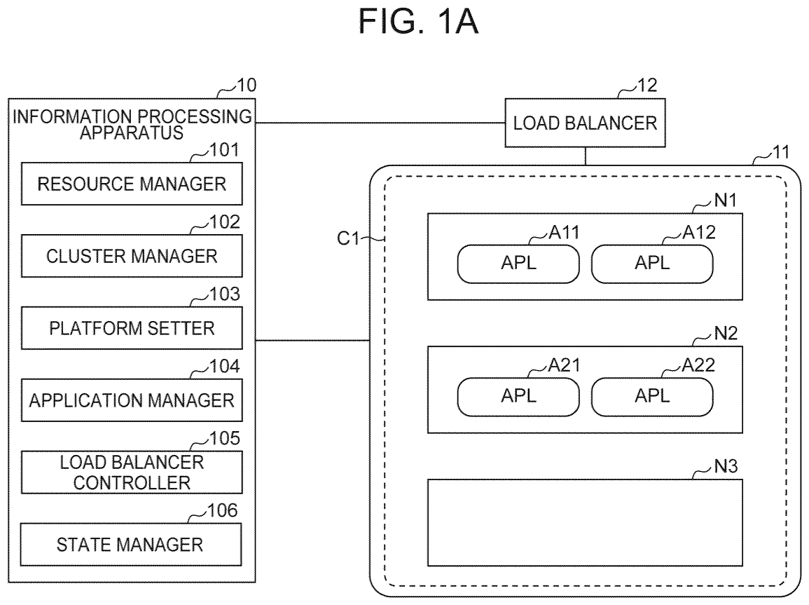

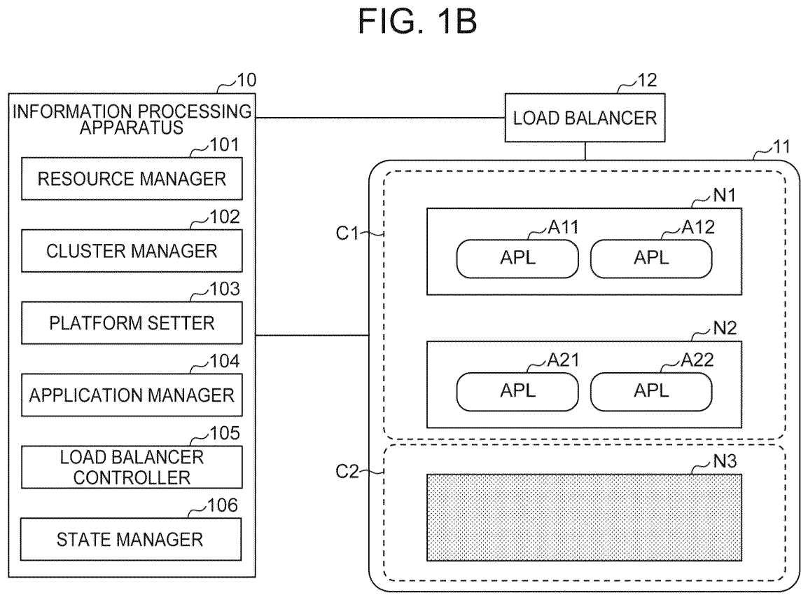

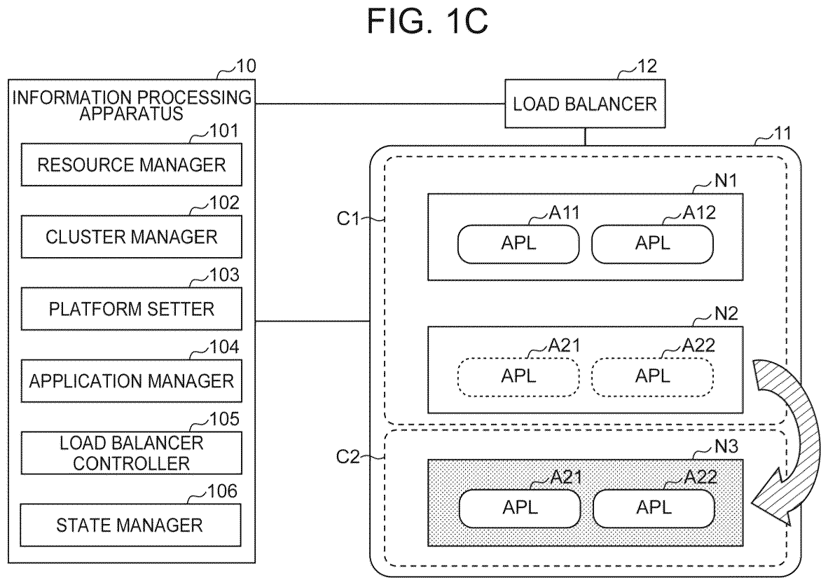

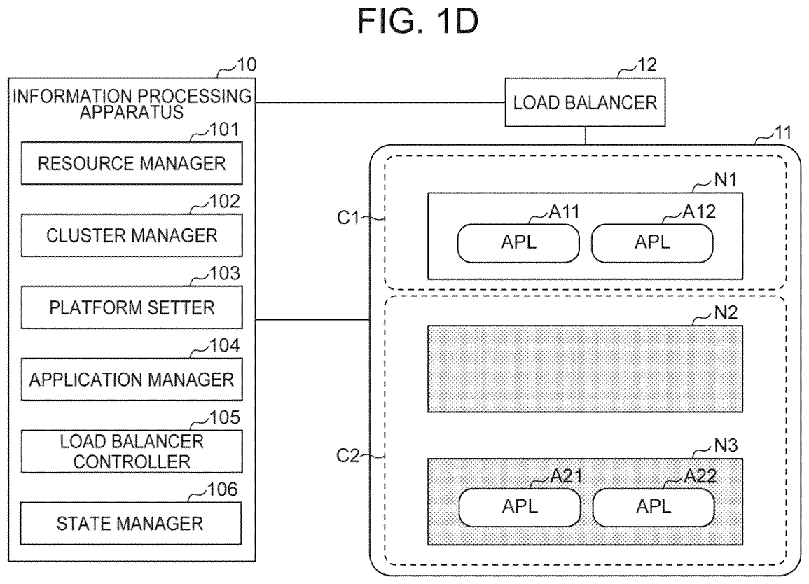

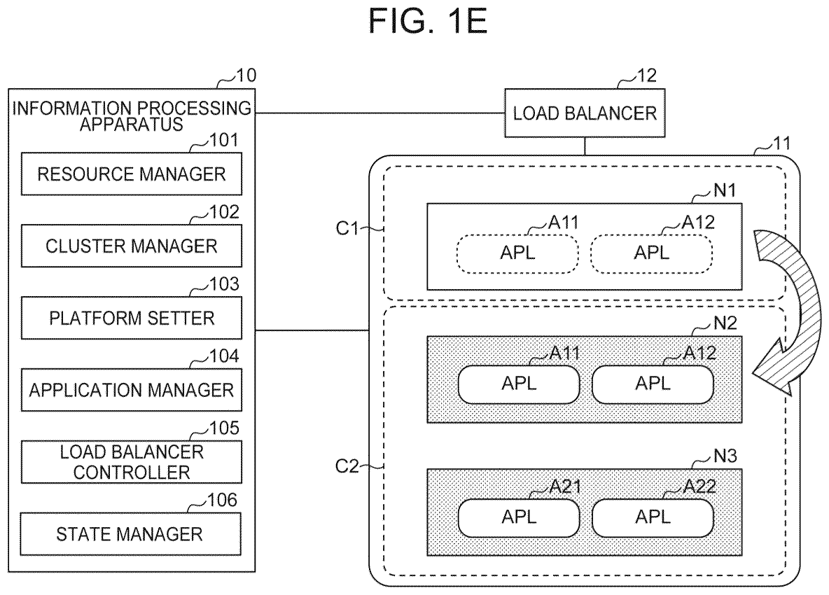

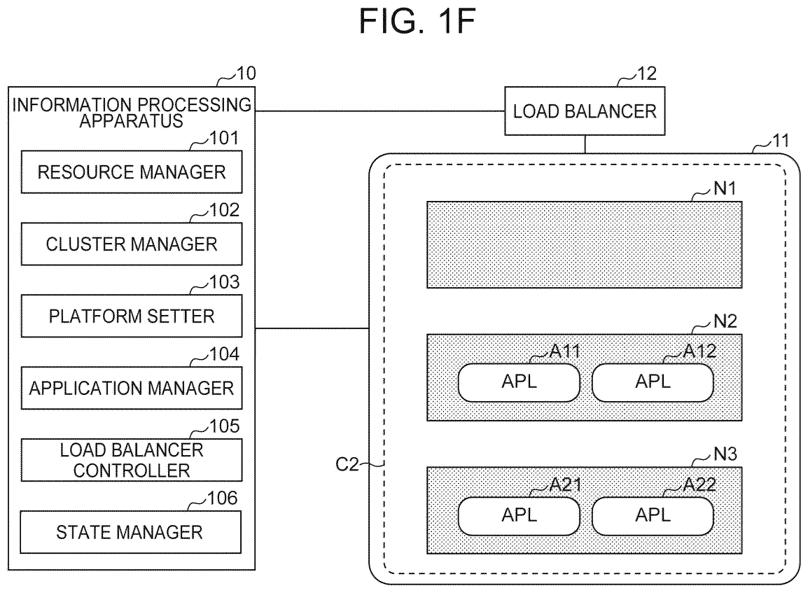

FIG. 1A illustrates a configuration example of an information processing system according to the present embodiment. The information processing system includes an information processing apparatus 10, a virtualization system 11, and a load balancer 12. Note that, in FIG. 1A, the information processing apparatus 10, the virtualization system 11, and the load balancer 12 are described as separate components, but the information processing apparatus 10 may include at least one of the virtualization system 11 and the load balancer 12.

The information processing apparatus 10 includes a resource manager 101, a cluster manager 102, a platform setter 103, an application manager 104, a load balancer controller 105, and a state manager 106, and executes update and migration of the virtualization platform software to the virtualization system 11. Each component of the information processing apparatus 10 will be described later. The virtualization platform software is software for forming a virtualization platform on a plurality of physical servers (nodes) as described above, and is OpenStack or Kubernetes, for example.

The virtualization system 11 has a plurality of (=natural numbers of N>1) physical nodes (servers) (in the following description, a physical node is simply referred to as a node). The virtualization system 11 in the present embodiment has three nodes N1, N2, and N3. The nodes N1, N2, and N3 illustrated in FIG. 1A are each installed with first virtualization platform software, and a first virtualization platform is formed at the nodes N1, N2, and N3. In FIG. 1A, the nodes N1, N2, and N3 are each indicated by a white box indicating that, at the nodes N1, N2, and N3, the first virtual platform is formed by the first virtualization platform software. Note that the virtualization system 11 may include other components such as a switch (not illustrated).

Each of the nodes N1, N2, and N3 can execute various applications using the first virtualization platform by building one or more of various applications on the first virtualization platform. In the example of FIG. 1A, it is illustrated that the node N1 can execute applications A11 and A12, and the node N2 can execute applications A21 and A22. Each of the applications A11, A12, A21, and A22 is software for providing a service to a user. The nodes N1, N2, and N3 constitute a first cluster C1 as a group of nodes that execute various applications on the first virtualization platform.

The nodes N1, N2, and N3 may be but are not limited to nodes including similar resources (for example, data used by a program, a memory capacity necessary for operating software and hardware, a hardware capacity, and a processing speed of a central processing unit (CPU)). In addition, it is assumed that the nodes N1, N2, and N3 include resources for executing at least any two applications among the applications A11, A12, A21, and A22. That is, each of the nodes N1, N2, and N3 can execute at least any two applications of the applications A11, A12, A21, and A22.

In addition, in the present embodiment, it is assumed that at least a resource for one node is not allocated as a resource for executing an application in the virtualization system 11 (for example, 10% to 20% or more of the resources of all nodes of the virtualization system 11). That is, it is assumed that free resources (surplus resources) for at least one node are prepared in the virtualization system 11. This is to avoid application impact (service impact) in a case where a hardware failure occurs in any of the nodes that execute the application. In the example of FIG. 1A, an application executed in the first cluster C1 is not allocated to the node N3, and a resource of the node N3 is prepared as a free resource. In FIG. 1A, the entire node N3 is prepared as a free resource as described above, but it is sufficient if resources for at least one node are prepared by aggregating free resources in a plurality of nodes.

The load balancer 12 controls access to various applications built in the virtualization system 11. That is, the load balancer 12 controls allocation of access to each node in the virtualization system 11. In the present embodiment, the access is assumed to be access from a user, but is not limited thereto. In the present embodiment, the load balancer 12 is controlled by the information processing apparatus 10. Note that the load balancer 12 may be incorporated in the information processing apparatus 10 or may be incorporated in the virtualization system 11.

Next, each component of the information processing apparatus 10 will be described. The resource manager 101 manages resources of a plurality of nodes in the virtualization system 11. As described above, in the virtualization system 11, free resources for at least one node are prepared. The resource manager 101 aggregates (collates) the free resources to at least one node and secures (prepares) the at least one node as a reserved node. In the example of FIG. 1A, the resource manager 101 secures the node N3 as a reserved node.

The cluster manager 102 manages a cluster which is a group of nodes executing various applications on a specific virtualization platform. In the present embodiment, a first cluster C1 which is a group of nodes executing various applications on the first virtualization platform and a second cluster which is a group of nodes executing various applications on the second virtualization platform are managed. In addition, the cluster manager 102 may control whether or not to include a plurality of nodes in the virtualization system 11 in the first cluster or the second cluster (that is, association or disassociation with the first cluster or the second cluster). In the present embodiment, it is assumed that the second virtualization platform is a platform obtained by updating the first virtualization platform. Note that the present invention is not limited thereto, and the first virtualization platform and the second virtualization platform may be virtualization platforms formed by different software (for example, software intended to implement different platforms). An example of virtualization platforms formed by different software is a virtualization platform based on OpenStack (an example of a cloud platform) and a virtualization platform based on Kubernetes (a container orchestration platform). In addition, the present invention is not limited to these examples, and it is sufficient if the first virtualization platform and the second virtualization platform are at least partially different virtualization platforms.

The platform setter 103 performs control for forming a virtualization platform in a plurality of nodes by setting the virtualization platform for the plurality of nodes in the virtualization system 11. The setting may be performed by installing or updating the virtualization platform software in a plurality of nodes. In the present embodiment, the platform setter 103 performs control for forming a second virtualization platform (that is, a new virtualization platform) for the nodes N1, N2, and N3 in which the first virtualization platform (that is, existing virtualization platforms) is formed in the virtualization system 11.

The application manager 104 performs control for migrating an application executed on the virtualization platform. In the present embodiment, between the nodes N1, N2, and N3, the application manager 104 migrates the application built in the node in which the first virtualization platform is formed to the node in which the second virtualization platform is formed. Specifically, the application manager 104 builds the application built in the node in which the first virtualization platform is formed in the node in which the second virtualization platform is formed. Then, after the building is completed, the application manager 104 deletes the application built in the node in which the first virtualization platform is formed.

The application manager 104 migrates the application to be compatible with the second virtualization platform. For example, an application operating on the first virtualization platform may not operate on the second virtualization platform. Therefore, when the application needs to be modified or changed in order to operate on the second virtualization platform at the time of migration of the application, the application manager 104 performs the migration after performing the modification or change. When the modification or change is not necessary, the application manager 104 directly migrates the application before migration to the migration destination node. Whether or not it is necessary to modify or change the application may be instructed in advance from an operator or an external system (neither is illustrated) to the application manager 104, or may be determined on the basis of an internal program or the like.

The load balancer controller 105 controls the load balancer 12 and switches access to various applications built in the virtualization system 11.

The state manager 106 manages the state in the virtualization system 11 in operation of update and migration of the virtualization platform software.

### Operation of Update and Migration of Virtualization Platform Software

Next, with reference to FIGS. 1A to 1F, the flow of the operation of updating and migrating the virtualization platform software at the nodes N1, N2, and N3 of the virtualization system 11 will be described. FIGS. 1A to 1F illustrate a configuration example of an information processing system according to the present embodiment, and the virtualization system 11 illustrated in FIG. 1A is in an initial state before update and migration of virtualization platform software. Hereinafter, the transition of the state of the virtualization system 11 will be described with reference to FIGS. 1A to 1F, and it is assumed that the migration proceeds to the next state after the state manager 106 confirms that the virtualization system normally operates in each state. Description of the communication process for the confirmation will be omitted.

In the state of FIG. 1A, as described above, the resource manager 101 secures the node N3 as a reserved node. Note that, in a state before the state of FIG. 1A, in a case where one or more applications are built on the first virtualization platform in all of the nodes N1, N2, and N3, the resource manager 101 migrates the application and secures a reserved node. For example, the resource manager 101 ensures the node N3 as a reserved node by aggregating (migrating) one or more applications in the node N3 to one or more nodes different from the node N3. In this state, the cluster manager 102 separates the node N3 from the first cluster C1. Subsequently, the virtualization system 11 transitions from the state of FIG. 1A to the state of FIG. 1B, where the platform setter 103 forms a second virtualization platform for the node N3. In FIG. 1B, the node N3 is indicated by a shaded box, indicating that a second virtual platform is formed at the node N3. In addition, the cluster manager 102 includes the node N3 in the second cluster C2 (associates the node N3 with the second cluster C2).

Next, the virtualization system 11 transitions from the state of FIG. 1B to the state of FIG. 1C, where the application manager 104 migrates the applications A21 and A22 built on the first virtualization platform of the node N2 to the node N3. Specifically, the application manager 104 builds the applications A21 and A22 on the second virtualization platform of the node N3 so as to be compatible with the second virtualization platform. After the applications A21 and A22 are normally built in the node N3, the application manager 104 deletes the applications A21 and A22 built in the node N2. When the applications A21 and A22 are deleted, the node N2 enters a state in which an application executed in the first cluster C1 is not built on the first virtualization platform. The completion of the migration of the applications A21 and A22 to the node N3 may be detected by the state manager 106.

In addition, in the state of FIG. 1C, before migration of applications A21 and A22 to the node N3 is completed, that is, before applications A21 and A22 are deleted from the node N2, access to applications A21 and A22 should be directed to the node N2. On the other hand, after the migration of the applications A21 and S22 to the node N3 is completed, that is, after the applications A21 and A22 are deleted from the node N2, the accesses to the applications A21 and A22 should be directed to the node N3. For this reason, the load balancer controller 105 controls the load balancer 12 so that access to the applications A21 and A22 is directed to the node N2 before the migration of the applications A21 and A22 to the node N3 is completed, and the access is switched and directed to the node N3 after the migration is completed. The timing at which the switching can be performed can be instructed by the state manager 106 to the load balancer controller 105.

Next, the virtualization system 11 transitions from the state of FIG. 1C to the state of FIG. 1D, where the platform setter 103 forms a second virtualization platform in the node N2. Similar to FIG. 1B, in FIG. 1D, the node N2 is indicated by a shaded box, indicating that a second virtual platform is formed at the node N2. In addition, the cluster manager 102 includes the nodes N2 and N3 in the second cluster C2 (associates the nodes N2 and N3 with the second cluster C2).

Next, the virtualization system 11 transitions from the state of FIG. 1D to the state of FIG. 1E, where the application manager 104 migrates the applications A11 and A12 built in the node N1 to the node N2. Similar to the description in FIG. 1C, application manager 104 builds applications A11 and A12 on the second virtualization platform of node N2 to be compatible with the second virtualization platform. After the applications A11 and A12 are successfully built in the node N2, the application manager 104 deletes the applications A11 and A12 built in the node N1. When the applications A11 and A12 are deleted, the node N1 enters a state in which an application executed in the first cluster C1 is not built on the first virtualization platform. The completion of the migration of the applications A11 and A12 may be detected by the state manager 106.

Furthermore, similarly to the description in FIG. 1C, in the state of FIG. 1E, the load balancer controller 105 controls the load balancer 12 so that access to the application A11 and the application A12 is directed to the node N1 before the migration of the application A11 and the application A12 to the node N2 is completed, and the access is switched and directed to the node N2 after the migration is completed. The timing at which the switching can be performed can be instructed by the state manager 106 to the load balancer controller 105.

Next, the virtualization system 11 transitions from the state of FIG. 1E to the state of FIG. 1F, where the platform setter 103 forms a second virtualization platform in the node N1. Similar to FIG. 1B, in FIG. 1E, the node N1 is indicated by a shaded box, indicating that a second virtual platform is formed at the node N1. In addition, the cluster manager 102 includes the nodes N1, N2, and N3 in the second cluster C2 (associate nodes N1, N2, and N3 with the second cluster C2).

Such a sequence of operations creates a second virtualization platform updated from the first virtualization platform at all of nodes N1, N2, and N3 without requiring additional resources for the existing virtualization system 11. Further, all of applications A11, A12, A21, and A22 that were operating on the first virtualization platform are migrated to nodes N1, N2, and N3 so as to be executable on the second virtualization platform without requiring additional resources.

### Processing Flow of Information Processing Apparatus

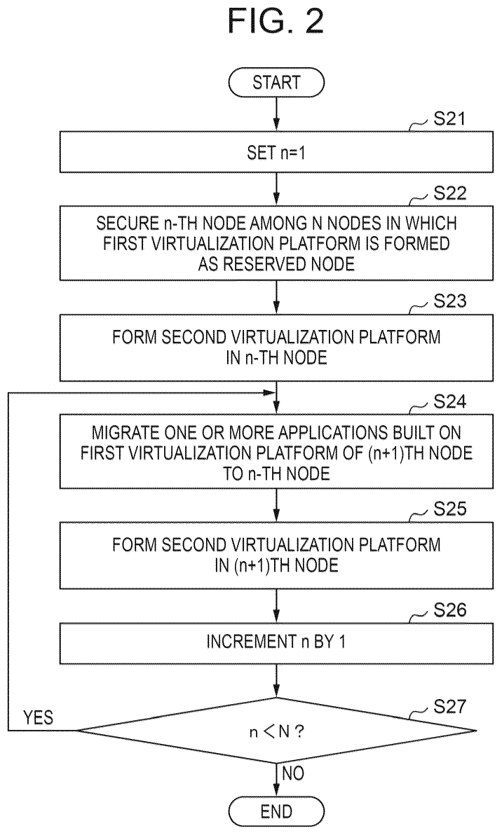

FIG. 2 is a flowchart of processing executed by the information processing apparatus 10. In the description of the present process, FIGS. 1A to 1F will be referred to. It is assumed that the virtualization system 11 includes N nodes (in the example of FIGS. 1A to 1F, N=3), a first virtualization platform is formed in all the N nodes, and a first cluster C1 is configured by all the N nodes in an initial state. Note that the description of the process of switching the access to the application will be omitted.

In S21, the state manager 106 sets a variable n that takes an integer to 1. Subsequently, in S22, the resource manager 101 secures (prepares) the n-th node among the N nodes in which the first virtualization platform is formed as a reserved node. The cluster manager 102 separates the reserved node from the first cluster C1. As described above, in the virtualization system 11, free resources for at least one node are prepared. The resource manager 101 aggregates the free resources to the n-th node. Although one reserved node is secured in FIG. 2, two or more reserved nodes may be secured.

In S23, the platform setter 103 sets the second virtualization platform for the n-th node, thereby forming the second virtualization platform in the n-th node. When the second virtualization platform is formed in the n-th node, in S24, the application manager 104 migrates one or more applications built on the first virtualization platform of the (n+1)th node to the n-th node. Specifically, the application manager 104 builds one or more applications built on the first virtualization platform of the (n+1)th node on the second virtualization platform of the n-th node. Then, after the building is completed, the application manager 104 deletes one or more applications built on the first virtualization platform of the (n+1)th node. As a result, the one or more applications on the first virtualization platform of the (n+1)th node migrate to the second virtualization platform of the n-th node. In addition, an application executed in the first cluster C1 is not built on the first virtualization platform of the (n+1)th node.

In S25, the platform setter 103 sets the second virtualization platform for the (n+1)th node, thereby forming the second virtualization platform in the (n+1)th node. In S26, the state manager 106 increments the variable n by 1, and in S27, the state manager 106 determines whether the variable n is less than N. When the variable n is less than N, the process proceeds to S24, and when the variable n is not less than N (that is, when n=N), the process ends. That is, the state manager 106 performs control to repeat the application migration process (S24) and the second virtualization platform formation process (S25) until the second virtualization platform is formed in all the N nodes. In a case where there is one reserved node, the state manager 106 performs control to repeat the process of S24 and S25 (N−1) times (perform N−1 times). As a result, it is possible to form the second virtualization platform without requiring additional resources for all the N nodes, and it is possible to efficiently perform the necessary application migration preferentially from the node on which the second virtualization platform is formed.

Note that, in FIG. 2, one or more applications built on the first virtualization platform of the (n+1)th node have been migrated to the n-th node, but may be migrated to another node having more remaining resources. For example, the resource manager 101 of the information processing apparatus 10 checks remaining resources (resource availability) of one or more nodes on which the second virtualization platform is formed, and determines one node from the one or more nodes on the basis of the remaining resources. Then, the application manager 104 may migrate one or more applications built on the first virtualization platform of the (n+1)th node to the determined node.

The present embodiment is also applicable to edge computing. Edge computing means distributed computing in which a server (edge server) is deployed at the periphery (edge) of a network and an application is executed on the edge server.

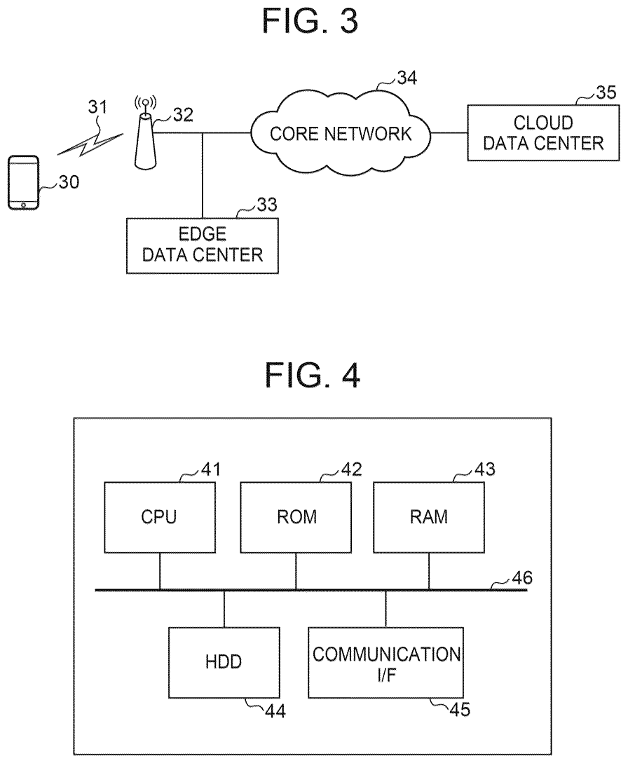

FIG. 3 illustrates a network configuration example of a communication system with edge computing. The user equipment (UE) 30 is connected to a radio base station 32 via a wireless network 31, and the radio base station 32 is connected to the cloud data center 35 via an upper core network 34 (and an external network (not illustrated)). The cloud data center 35 is a main data center and is an example of a data center including upper-level server. The wireless network 31 and the core network 34 are compliant with, for example, the 5th generation (5G) or the 6th generation (6G) standard in the 3rd generation partnership project (3GPP (registered trademark)).

The edge data center 33 is disposed so as to be able to communicate with the base station 32 without going through the core network 34. The plurality of nodes of the virtualization system 11 described with reference to FIGS. 1A to 1F may constitute an edge data center 33. The cloud data center 35 provides services to the UE 30 through the core network 34 and the wireless network 31, whereas the edge data center 33 can provide services to the UE 30 without going through the core network 34. Therefore, due to the arrangement of the edge data center 33, not only a service can be provided to the UE 30 more quickly, but also a processing load in the cloud data center 35 can be suppressed. Furthermore, in general, the resources of the edge data center 33 are very limited, but by applying the present embodiment, it is possible to efficiently update the virtualization platform software and migrate the application associated therewith.

As described above, according to the present embodiment, a new virtualization platform can be formed by new software without requiring additional resources for a plurality of nodes included in the virtualization system 11 and on which existing virtualization platforms are formed. It also allows applications on existing virtualization platforms to migrate onto new virtualization platforms without requiring additional resources. Further, in this embodiment, a processing delay caused by using an additional resource can be avoided, and efficient update and migration of virtualization platform software using an existing resource can be implemented.

Note that, in the present embodiment, the migration from the first virtualization platform software to the second virtualization platform software in the virtualization system 11 has been described, but the virtualization environment may not be implemented in advance in the virtualization system 11. For example, the present embodiment is also applicable when a virtualization system 11 in a non-virtualized environment (bare-metal) forms another type of non-virtualized environment or a first or second virtualization platform.

### Hardware Configuration of Information Processing Apparatus

FIG. 4 illustrates a hardware configuration example of the information processing apparatus 10 according to the present embodiment. As illustrated in FIG. 4, the information processing apparatus 10 includes, as an example of a hardware configuration, a central processing unit (CPU) 41, a read only memory (ROM) 42, a random access memory (RAM) 43, a hard disk drive (HDD) 44, a communication interface (I/F) 45, and a system bus 46. The information processing apparatus 10 may also include an external memory.

The CPU 41 includes one or more CPUs (processors), and comprehensively controls operation in the information processing apparatus 10. The CPU 41 controls each component (42 to 45) via the system bus 46 which is a data transmission path. At least one of the one or more CPUs may be replaced with one or more processors such as an application specific integrated circuit (ASIC), a field programmable gate array (FPGA), a digital signal processor (DSP), and a graphics processing unit (GPU).

The ROM 42 is a nonvolatile memory that stores a control program and the like necessary for the CPU 41 to execute processing. Note that the program may be stored in a non-volatile memory such as the HDD 44 or a solid state drive (SSD), or an external memory such as a detachable storage medium (not illustrated).

The RAM 43 is a volatile memory, and functions as a main memory, a work area, and the like of the CPU 41. That is, the CPU 41 loads a necessary program or the like from the ROM 42 into the RAM 43 in performing process, and executes the program or the like to perform various functional operations.

In the HDD 44, for example, various kinds of data, various kinds of information, and the like required for the CPU 41 to perform processing using a program, are stored. Further, in the HDD 44, for example, various kinds of data, various kinds of information, and the like acquired by processing performed by the CPU 41 using a program, are stored. Note that the storage may be achieved using a non-volatile memory such as an SSD or an external memory such as a detachable storage medium, together with the HDD 44, or instead of the HDD 44.

The communication I/F 45 is an interface that controls communication between the information processing apparatus 10 and an external device.

Note that the information processing apparatus 10 may include dedicated hardware that executes each function of each apparatus, or may execute a part of all the functions of each apparatus by hardware and execute the other parts by a computer that operates a program. Further, all the functions may be executed by a computer and a program. In addition, a program that realizes at least one or more functions of all functions may be supplied to a system or an apparatus via a network or a storage medium, and one or more processors in a computer of the system or the apparatus may read and execute the program.

While the specific embodiment has been described above, the embodiment is merely an example, and is not intended to limit the scope of the present disclosure. The devices and methods described in the present specification can be embodied in other forms than those described above. In addition, omissions, substitutions, and changes can be appropriately made to the above-described embodiment without departing from the scope of the present disclosure. Forms with such omissions, substitutions, and changes are included in the scope of what is described in the claims and equivalents thereof, and belong to the technical scope of the present disclosure.

The present disclosure includes the following embodiments.

[1] An information processing apparatus configured to perform: a preparation process of preparing, as one or more reserved nodes, one or more nodes in which one or more applications are not built on a first virtualization platform among N nodes in which the first virtualization platform is formed; a first formation process of forming a second virtualization platform in the one or more reserved nodes; a migration process of migrating the one or more applications built on the first virtualization platform formed in a first node among the N nodes to any second node among the one or more nodes in which the second virtualization platform is formed; a second formation process of forming the second virtualization platform in the first node; and a control process of performing control to repeat the migration process and the second formation process until the second virtualization platform is formed in all of the N nodes.

[2] An information processing apparatus configured to perform: a first setting process of setting a variable n to 1; a preparation process of preparing an n-th node in which one or more applications are not built on a first virtualization platform among N nodes from first to N-th (natural numbers of N>1) in which the first virtualization platform is formed; a first formation process of forming a second virtualization platform in the n-th node; a migration process of migrating the one or more applications built on the first virtualization platform of an (n+1)th node among the N nodes to the n-th node; a second formation process of forming the second virtualization platform in the (n+1)th node; a second setting process of incrementing n by 1; and a control process of performing control to repeat the migration process, the second formation process, and the second setting process until the second virtualization platform is formed in all of the N nodes.

[3] The information processing apparatus according to [1] or [2], in which the preparation process includes preparing the one or more reserved nodes by migrating the one or more applications in the one or more reserved nodes to one or more nodes different from the one or more reserved nodes when the one or more applications are built on the first virtualization platform in all of the N nodes.

[4] The information processing apparatus according to any one of [1] to [3], in which the migration process includes modifying the one or more applications built on the first virtualization platform formed in the first node to match the second virtualization platform, and migrating the modified one or more applications to the second node.

[5] The information processing apparatus according to any one of [1] to [4], in which the migration process includes determining a node based on availability of resources of one or more nodes in which the second virtualization platform is formed, and migrating the one or more applications built on the first virtualization platform formed in the first node to the determined node.

[6] The information processing apparatus according to any one of [1] to [5], in which the N nodes constitute a data center for edge computing.

[7] The information processing apparatus according to any one of [1] to [6], in which the second virtualization platform is a virtualization platform updated on the basis of the first virtualization platform.

[8] The information processing apparatus according to any one of [1] to [6], in which the first virtualization platform and the second virtualization platform are virtualization platforms formed by different software.

1. An information processing apparatus comprising
one or more processors, wherein at least one of the one or more processors is configured to perform:
a preparation process of preparing, as one or more reserved nodes, one or more nodes in which one or more applications are not built on a first virtualization platform among a plurality of nodes in which the first virtualization platform is formed;
a first formation process of forming a second virtualization platform in the one or more reserved nodes;
a migration process of migrating the one or more applications built on the first virtualization platform formed in a first node among the plurality of nodes to any second node among the one or more nodes in which the second virtualization platform is formed;
a second formation process of forming the second virtualization platform in the first node; and
a control process of performing control to repeat the migration process and the second formation process until the second virtualization platform is formed in all of the plurality of nodes.

2. The information processing apparatus according to claim 1,
wherein the preparation process includes preparing the one or more reserved nodes by migrating the one or more applications in the one or more reserved nodes to one or more nodes different from the one or more reserved nodes when the one or more applications are built on the first virtualization platform in all of the plurality of nodes.

3. The information processing apparatus according to claim 1,
wherein the migration process includes modifying the one or more applications built on the first virtualization platform formed in the first node to match the second virtualization platform, and migrating the modified one or more applications to the second node.

4. The information processing apparatus according to claim 1,
wherein the migration process includes determining a node based on availability of resources of one or more nodes in which the second virtualization platform is formed, and migrating the one or more applications built on the first virtualization platform formed in the first node to the determined node.

5. The information processing apparatus according to claim 1, wherein the plurality of nodes constitute a data center for edge computing.

6. The information processing apparatus according to claim 1, wherein the second virtualization platform is a virtualization platform updated based on the first virtualization platform.

7. The information processing apparatus according to claim 1, wherein the first virtualization platform and the second virtualization platform are virtualization platforms formed by different software.

8. An information processing apparatus comprising
one or more processors, wherein at least one of the one or more processors is configured to perform:
a first setting process of setting a variable n to 1;
a preparation process of preparing an n-th node in which one or more applications are not built on a first virtualization platform among N nodes from first to N-th (natural numbers of N>1) in which the first virtualization platform is formed;
a first formation process of forming a second virtualization platform in the n-th node;
a migration process of migrating the one or more applications built on the first virtualization platform of an (n+1)th node among the N nodes to the n-th node;
a second formation process of forming the second virtualization platform in the (n+1)th node;
a second setting process of incrementing n by 1; and
a control process of performing control to repeat the migration process, the second formation process, and the second setting process until the second virtualization platform is formed in all of the N nodes.

9. An information processing method executed by an information processing apparatus, the method comprising:
preparing, as one or more reserved nodes, one or more nodes in which one or more applications are not built on a first virtualization platform among a plurality of nodes in which the first virtualization platform is formed;
forming a second virtualization platform in the one or more reserved nodes;
migrating the one or more applications built on the first virtualization platform formed in a first node among the plurality of nodes to any second node among the one or more nodes in which the second virtualization platform is formed;
forming the second virtualization platform in the first node; and
performing control to repeat the mitigating and the forming the second virtualization platform in the first node until the second virtualization platform is formed in all of the plurality of nodes.
